(19) United States
(12) Patent Application Publication
(10) Pub. No.: US 2008/0016302 A1
(43) Pub. Date: Jan. 17, 2008

(54) Method of mass duplication

(75) Inventors: Sung-Jung Wang, Taipei County (TW); Tai-Ching Chiu, Taipei County (TW); Shih-Chiang Tsao, Hsinchu City (TW)

Correspondence Address: BIRCH STEWART KOLASCH & BIRCH, PO BOX 747, FALLS CHURCH, VA, 22040-0747, US

(73) Assignee: AN CHEN COMPUTER CO., LTD.

(21) Appl. No.: 11/485,434

(22) Filed: Jul. 13, 2006

(51) Int. Cl. G06F 13/00

(52) U.S. Cl. 711/162

(57) ABSTRACT

A method for duplicating data of a source medium to a plurality of target media through a duplicator includes connecting the source medium and the target media to the duplicator. The duplicator transfers the data of the source medium to the target media in an order and repeatedly. The target media receive the data from the source medium and write them on the corresponding addresses until all of the data of the source medium had been copied to the target media. The duplicator call user to replace the target medium, which had completed duplication, with a new target medium. When replace one of the target media, the rest target media are duplicating data independently without any interruption by replacement of the target medium.

### BACKGROUND OF THE INVENTION

1. Field of the Invention

The present invention relates generally to a duplicating method, and more particular to a method for duplicating a plurality of copies of data.

2. Description of the Related Art

In some certain industries, such as PC manufacturers and mass storage device manufacturers, it needs to duplicate data to one or more mass storage devices, such as hard disk, flash memory and the like. It is very important to have a duplicator for duplicating data stably and quickly. Typically, a duplicator includes a source connector, on which a source medium is connected, and a plurality of target connector, on each of which a target medium is connected. The duplicator copies the data of the source medium to the target media.

In the prior art, there are many methods and systems for duplication. For example, Bodo, U.S. Pat. No. 5,777,811, taught a data duplicating system, which is a standard computer system and is broadly utilized in present day's PCs. Basically, Bodo's system sends the copied data to a main memory, which usually is RAM (Random Access Memory), then writes the copied data to a target storage device. Such data transfer system is reliable but the transfer speed will be affected by the accessing, read and write, and calculating speed of CPU. Another duplication system is Ravid's invention, U.S. Pat. No. 6,131,141, which discloses a HDD (hard disk drive) duplicator, which is connectable to a computer as operation interface. The patent taught means for controlling the copied data flowing to target HDDs from the source HDD directly. Between the data path, there is no memory buffer for temporary storage of copied data to have a high speed of data duplication. The third patent is Chou's invention, U.S. Pat. No. 6,931,459, which provides FIFO (First-In-First-Out) memories to be the buffer of data transferring.

Above inventions are working on how to transfer the data from the source medium to the target media in a faster and reliable way. In the real duplication action, the source medium and the target media are connected to the duplicator first for duplication process. After the data of the source medium had been copied to the target media, the duplicator is stopped and waits for replacement of blank target media. We are aware of that the replacement process is the main issue of elongating the time of duplication.

### SUMMARY OF THE INVENTION

The primary objective of the present invention is to provide a method of mass duplication, which may shorten the time of replacement of target media.

According to the objective of the present invention, a method for duplicating data of a source medium to a plurality of target media through a duplicator includes connecting the source medium and the target media to the duplicator. The duplicator transfers the data of the source medium to the target media in an order and repeatedly. The target media receive the data from the source medium and write them on the corresponding addresses until all of the data of the source medium had been copied to the target media. The duplicator call user to replace the target medium, which had completed duplication, with a new target medium. When replace one of the target media, the rest target media are duplicating data independently without any interruption by replacement of the target medium.

### BRIEF DESCRIPTION OF THE DRAWINGS

FIG. 1 is a flow chart of a preferred embodiment of the present invention;

FIG. 2 to FIG. 6 are sketch diagrams of the preferred embodiment of the present invention, showing the process of duplication.

### DETAILED DESCRIPTION OF THE INVENTION

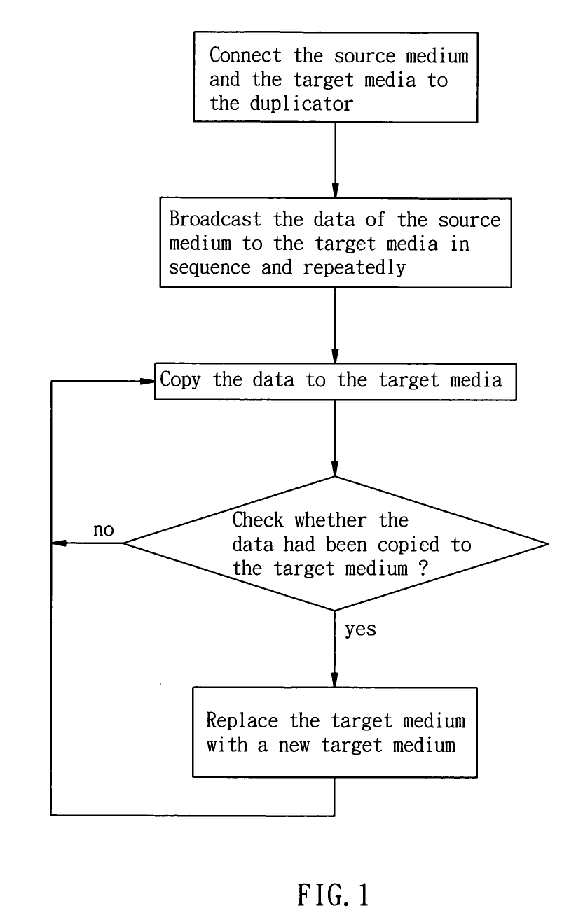

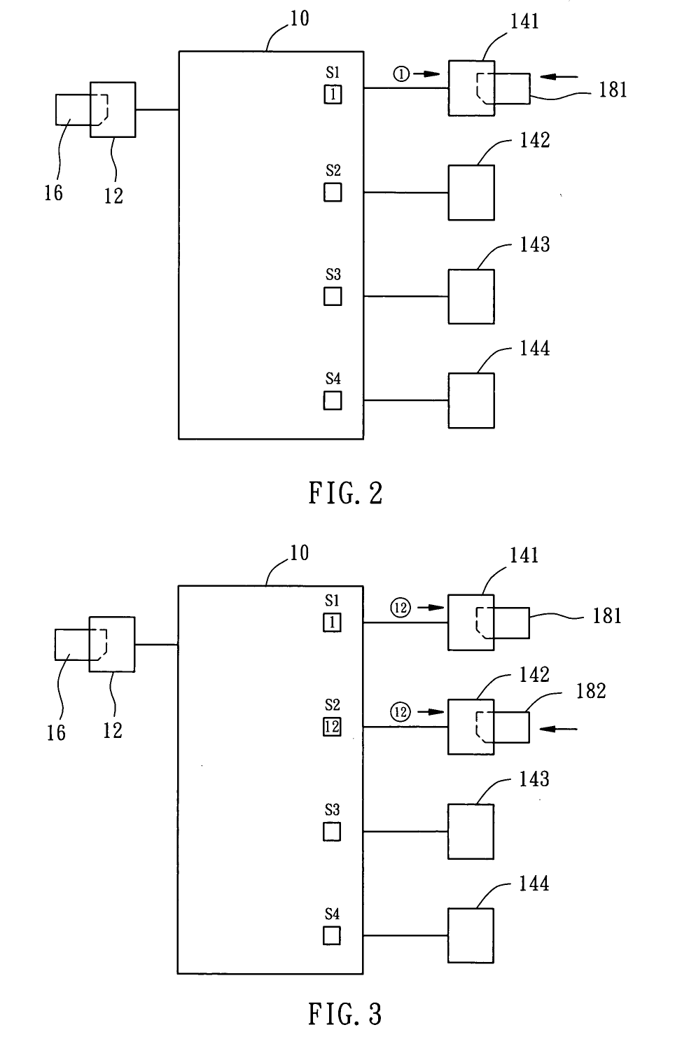

FIG. 1 is a flow chart of a method for duplicating data of a source medium to a plurality of target media through a duplicator. FIG. 2 shows the duplicator 10, which includes a source connector 12 and four target connectors 141˜144. The source medium 16 may be connected to the source connector 12 and four target media 181˜184 are detachably connected to the target connectors 141˜144 respectively. The media may be flash memory cards, hard disks, floppy disks, compact disks (CD), digit video disks (DVD) or other types of mass storage devices or the combination of above. In the drawings, the source medium 16 and the target media 181˜184 are Secure Digital Card (SD card).

As shown in FIG. 2, before duplication, user has to connect the source medium 16 to the source connector 12 of the duplicator 10 first, and then connect the first target medium 181 to the first target connector 141. When the duplicator 10 detects the first target connector 141 connected, it will start the duplicating process automatically. The duplicator 10 transfers data of the source medium 16, in a way of broadcasting, to the first target medium 181 through the first target connector 141 repeatedly and in a predetermined order. We assume that the source medium 16 has a hundred data, and we define them as no. 1 datum, no. 2 datum . . . , and no. 100 datum. The duplicator 10 transfer no. 1 datum to no. 100 datum in sequence to the target medium 181, and after that the duplicator 10 transfers no. 1 datum to no. 100 datum repeatedly.

The duplicator 10 records a first comparing datum S1 which is the first datum that the first target medium 181 receives from the source medium 16. In this moment, the first comparing datum S1 is the no. 1 data. In the same time, the duplicator 10 writes the no. 1 data into a corresponding address of the first target medium 181. In the next moment, the duplicator 10 transfers no. 2 datum of the source medium 16 to the first target medium 181, and the duplicator 10 compares the no. 2 datum with the first comparing datum S1. If they are different, the duplicator 10 writes the no. 2 datum into a corresponding address of the first target medium 181. This step is to check whether the entire data of the source medium 16 had been copied to the target medium 181? If the datum transferring to the target medium 181 is as same as the comparing datum S1, it means the duplicator 10 had transferred the entire data of the source medium 16 to the target medium 181. If they are different, it means there still are data not transferring to the target medium 181.

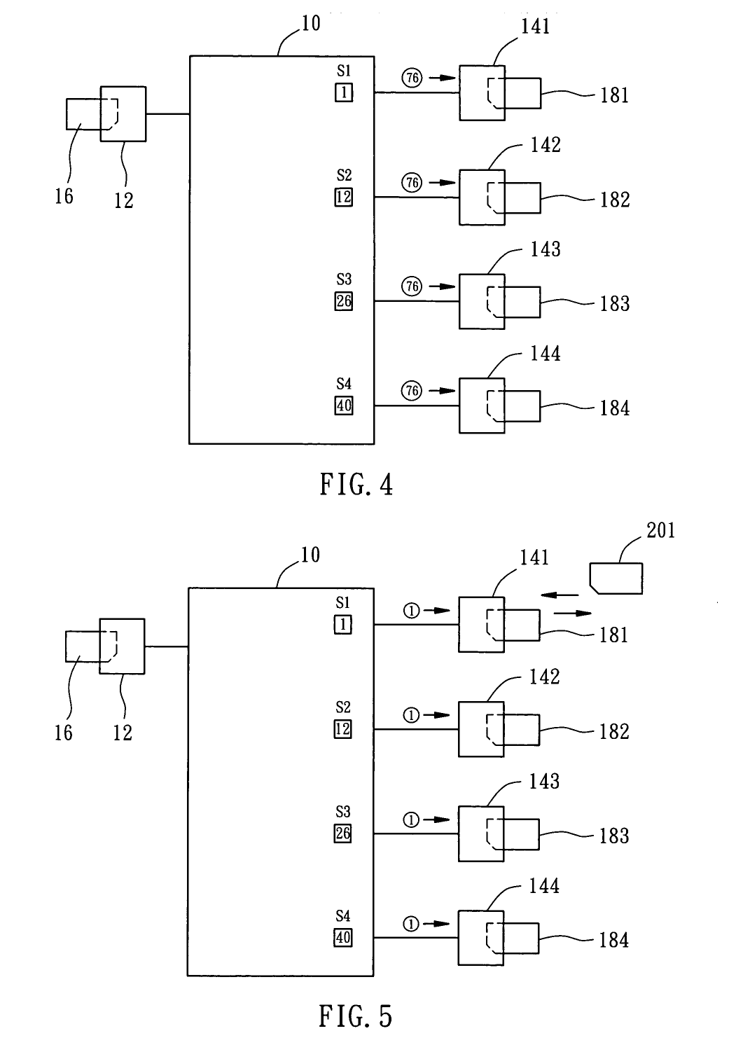

The second target medium 182 will start to receive the data from the source medium 16 automatically soon after it is connected to the second target connector 142. As shown in FIG. 3, we assume that user connects the second target medium 182 to the second target connector 142 just before the duplicator 10 transfers no. 12 datum. It means the second target medium 182 receives the first datum from the source medium 16 is no. 12 datum that the duplicator 10 records no. 12 in a second comparing datum S2 and writes the no. 12 datum to a corresponding address of the second target medium 182. For the same principle, we assume that user connects the first and fourth target media 183, 184 just before the duplicator 10 transfers no. 26 datum and no. 40 datum respectively, and the duplicator 10 records no. 26 datum and no. 40 datum in the third and fourth comparing data S3 and S4 respectively, as shown in FIG. 4. FIG. 4 also shows the duplicator 10 transferring no. 76 data to the target media 181˜184.

It is noted that the comparing data S1˜S4 record the addresses of the first data that target media 181˜184 receive from the source medium 16 after that target media 181˜184 are connected to the target connectors 141˜144 of the duplicator 10. Because the duplicator 10 transfers the data of the source medium 16 in sequence and repeatedly, it means the entire data of the source medium 16 had been copied to the target medium 181˜184 when the duplicator 10 finds that the address of the datum from the source medium 16 had been written with datum, in other words, the address of datum from the source medium 16 is as same as the comparing datum S1˜S4. Any method that may identify whether the entire data of the source medium 16 had been copied to the target media 181˜184 may be utilized in the present invention.

As shown in FIG. 5, when the duplicator 10 had transferred all of the 100 data of the source medium 16 to the target media 181˜184, and then it will repeat to transfer no. 1 datum again. In the meantime, the duplicator 10 will find the entire data of the source medium 16 had been copied to the target medium 181 by means of comparing the address of the datum transferring to the target medium 181 with the first comparing datum S1, and finding they are the same. The duplicator 10 will stop transferring data to the first target connector 141 and request user to replace the target medium 181 with a new target medium 201 by an alarm.

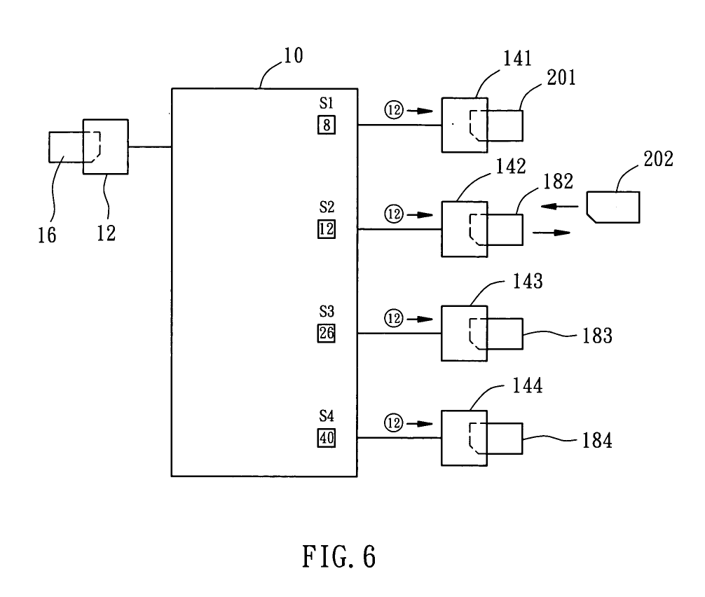

As shown in FIG. 6, we assume that the target medium 201 is connected to the first target connector 141 just before no. 8 datum, so that the first comparing datum records the address of no. 8 datum. When the duplicator 10 transfers no. 12 datum and finds the address of no. 12 datum is as same as the second comparing datum S2, the duplicator 10 will stop transferring data to the second target connector 142 and alarm user to replace the target medium 182 with a new target medium 202.

Repeat the steps above, user may replace the target media that had completed the duplicating process one by one in various time. In the process of replacement the target medium, the rest target media keeps the duplicating process independently without any interruption by the replacement of the target medium.

The duplicator 10 will stop transferring data of the source medium 16 under two conditions, one of which is that the duplicator 10 detects no target medium connected, and the other of which is that no target medium is replaced when all of the target media had completed the duplicating process.

In conclusion, the duplicating process of each target medium starts and finishes in different time that the replacement of each target medium will not overlap. When the target medium is replaced, the rest target media are duplicating data independently without any interruption by the replacement the target medium. The new target medium may enter the data broadcasting in any time and start duplication. With all of the characters above, the method of the present invention may shorten the time delay by replacement of target media.

What is claimed is:

1. A method for duplicating data of a source medium to a plurality of target media through a duplicator, comprising the steps of:
a) connecting the source medium and the target media to the duplicator;
b) transferring the data of the source medium to the target media in a predetermined order and repeatedly;
c) receiving and writing the data of the source medium in corresponding addresses of the target media; and
d) checking whether all of the data of the source medium had been copied to the target media respectively? if do, taking the target medium off the duplicator and connecting a new target medium to the duplicator, and then repeating the step c; if don't, repeating the step c directly;
wherein when replace one of the target media, the rest target media are duplicating data independently without any interruption by replacement of the target medium.

2. The method as defined in claim 1, wherein each of the target media starts and finishes duplicating the data in different time.

3. The method as defined in claim 1, wherein a method of checking whether all of the data of the source medium had been copied to the target media respectively includes the steps of:
dl) recording the first data of each of the target media receiving from the source medium just after the target media are connected to the duplicator in a comparing datum; and
d2) comparing the data of each of the target media receiving from the source medium with the comparing datum; wherein if they are the same, it means that all of the data of the source medium had been copied to the target medium.

4. The method as defined in claim 1, wherein the comparing data record addresses of the first data of the target media receiving from the source medium, and the comparing data is compared with addresses of the data of the target media receiving from the source medium.

5. The method as defined in claim 1, further comprising the step of stopping transferring the data of the source medium to the target media when there is no target medium connected to the duplicator.

6. The method as defined in claim 1, further comprising the step of stopping transferring the data of the source medium to the target media when all of the target media had completed duplication.
